(19) United States
(12) Patent Application Publication
(10) Pub. No.: US 2004/0018354 A1
(43) Pub. Date: Jan. 29, 2004

(54) Underlayment for floating flooring comprising a sandwich membrane

(76) Inventor: Carlos Guillermo May, San Isidro -Buenos Aires (AR)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/266,686

(22) Filed: Oct. 9, 2002

(30) Foreign Application Priority Data
Jul. 24, 2002 (AR) P 2002 01 02792

(51) Int. Cl. B32B 9/00; B32B 7/12

(52) U.S. Cl. 428/317.3; 428/40.1

(57) ABSTRACT

Underlayment for a floating flooring includes a sandwiched membrane that may be used as a separator between the floating flooring and the rigid foundation thereof. The membrane includes a closed cell low-polyethylene foam whereto two polyethylene films are simultaneously heat-sealed. The films enwrap the foam in its entire width. An overlapping is formed that may overlap and pressure-fix over a self-adhesive strip of the first film of a similar sandwiched membrane adjacently extended and establishing a heading joint between the edges of the foam of both membranes and of the second film, belonging to this overlapping. The overlapping overlaps this heading joint and thus it makes a mechanical tight association between the first thicker film of both membranes, at the same time making a continuous vapor barrier between both membranes, an acoustic buffer and a damping element, which extends along the whole arrangement of sandwiched membranes over the floor.

This invention relates to an underlayment for floating flooring comprising a sandwiched membrane, which may be used as a separation between the floating flooring and a rigid foundation.

### STATE OF THE ART

Traditional flooring systems are comprised of a rigid foundation and the floor covering.

Said rigid foundation may be formed by a subfloor made of concrete or any other material, and/or in the case of existing floors, by a ceramic flooring, a hardwood plank, parquet flooring, and the like.

The floor covering is laid over any of the rigid surfaces previously mentioned.

Said floor covering may be wooden keeping the distinctive features of each type of wood and different type of pieces and anchoring methods.

Vinilic or rubber floorings are the highest resistant floor covering.

When wood floor covering is anchored directly over a rigid foundation, the result is a completely hard floor without any damping whatsoever thus leading people that perform their activities on these type of floors to suffer from tiredness and other physical conditions.

In an attempt to do away with the drawbacks posed by the rigidity of these floor coverings or other similar floorings wherein they are anchored, for example, over a wooden foundation laying over a concrete subfloor, the so called FLOATING FLOORING have been developed.

In this floating flooring system a separator, generally a polyethylene foam layer, is intercalated between the rigid foundation (concrete subfloor), and the floor covering (made of wood or melamine).

Polyethylene foam acts as a leveler of tiny unevenness of the concrete subfloor and also as a damping material and an acoustic buffer.

Polyethylene foam is available in strips, panels or the like, generally in rolls that are laid over the rigid foundation one by the other, without overlapping onto each other so as to avoid creating an over-thickening.

In same cases polyethylene foam is associated to a polyethylene film acting as a vapor barrier that is usually laid over the rigid foundation, either under or on the foam sheets, directly under the floating flooring. In any of these cases, the edge adjacent portions of the film sheets should be overlapped onto each other by a few centimeters, so they are not laid one next to the other so as to avoid any rupture during the process of floor anchoring.

There also exist products wherein the foam is coated with a polyethylene film previously fixed to the foam, having a protrusion on a marginal region; the protrusion forming an overlapping joint intended to cover the adjacent portion of the other sheet of foam belonging to the film edge opposite to its overlapping joint.

Those skilled in the art know and use this solution when they try to get tight joints between laminar elements horizontally laid and/or when slightly sloping surfaces are coated.

But in the case of underlayment used for floating flooring there is particular problem that goes beyond said overlapping, which not only requires that said underlayment be highly capable of acting as a damping material, acoustic buffer and vapor barrier, but also that it may be useful a free glide element relative to both the flooring and the rigid foundation. The purpose is that the foundation may work as a leveler of any unevenness of the rigid foundation without either establishing any sort of foam retention or requiring friction.

Not only the overlapping between the sheets is sought, but also characteristics completely different that furnish the foam layer with such features as those below mentioned.

A higher resistance to wood contraction, so as to evidently improve its resilience and extend its useful life as a damping element.

By way of the foam, to improve the free expansion and contraction of the flooring due to changes in climate, thus preventing that the foam may be affected by any mechanical aggression and adding another factor to extend the useful life of the foam.

Furnish the foam with a certain separation between the foundation and the flooring, which may fully protect it from any aggression that may restrict or limit its useful life, so their original features may remain unaffected.

It is a specific objective that the foam be water repellant at all times.

Finally, another essential objective of the invention is to achieve a constructive arrangement based on said key elements: 1) polyethylene foam and 2) polyethylene film. Having the above features, the constructive arrangement shall provide improved pull strength and tear strength.

Moreover, another essential objective of the invention is that such constructive arrangement may allow for the incorporation of a true, effective simplification of the joining process between the panels or sheets of foam and the film, so a direct joint between them is possible without using any additional means foreign to the basic elements, such as adhesive tapes or the like and also, through the arrangement or a series of arrangement the user may have clear directions as regards anchoring and use precautions.

### SUMMARY OF THE INVENTION

All these objectives as well some others that may be evident from the disclosure below, have been put into practice with the underlayment for floating flooring that is the subject matter of the present invention, characterized in that it has been basically developed as a series of successive panels, strips, sheets or the like, laid one beside the other which may be referred to as “sandwiched membrane” comprising a strip of closed cells low-density polyethylene foam, wherein two polyethylene films are heat-sealed to the foam; the films fully enwrap the foam; the first film is a thicker, low-density polyethylene film and extends beyond the edge of the foam in the shape of an overlapping portion.

This sandwiched membrane provides an overall better mechanical resistance than each single component thereof and it has substantially similar pull strength and tear strength on both sides.

The uncovered upper face of the wider film brings imprinted instructions for laying as well as use precautions and this same face brings beside its opposite edge at least one pressure-sensitive selfadhesive strip, the selfadhesive strip being longitudinally extended and preferably made of a hot melt that retains its properties indefinitely and which once the sealing is made shall be not affected by any external agent. The polyethylene foam preferably has a density between 18 kg/m³ (1.12 pcf) and 40 kg/m³ (2.5 pcf).

This sandwiched membrane makes a vapor barrier, an acoustic buffer and a mechanical damping, which is completely watertight and has basically the same gliding feature on both faces, as both are coated with polyethylene films.

This sandwiched membrane is anchored over the rigid foundation of the floating flooring, by its second film while the uncovered face of the first film bearing anchoring instructions and the selfadhesive strip shall be laid face up, one strip is laid beside the other and the overlapping region of the first film-upward face-overlaps and glues the edge strip opposite to the same face of the first film of the adjacent sandwiched membrane wherein the selfadhesive strip is furnished.

In this way only one integral surface is formed, the surface comprising the first film of all panels of the sandwiched membrane that are successively anchored, covering the whole surface of the rigid foundation upon which the floating flooring is placed completely separated from this underlayment; the underlayment formed by the series of panels of the sandwiched membrane, remains connected to each other only by the first film laying in a floating way between the flooring and said rigid foundation, each having a free gliding relative to the other.

### BRIEF DESCRIPTION OF THE DRAWINGS

The disclosure of the underlayment for the floating floor and the sandwiched membrane will be more clearly understood when taken in consideration with the figures, which illustrate one of the preferred embodiments of the invention, wherein:

FIG. 1 is a cross section view of the sandwiched membrane for the floating flooring of the invention, showing different elements thereof.

FIG. 2 is a view similar to FIG. 1, showing how the sandwiched membranes relate to each other in a first step of the foundation arrangement.

FIG. 3 is perspective, partial view showing the association between the membranes arranged according to FIG. 2.

FIG. 4 is a schematic view of the first step of the production process of the membrane.

FIG. 5 is a schematic view of the second, last step of said production process comprising the application of the adhesive for associating the membranes that make the underlayment of the floating flooring.

In all the different Figures the same symbols refer to the same elements or similar parts.

### DESCRIPTION

Sandwiched membrane A comprises a first low-density polyethylene film 10, which is between 25 mic (1 mils) and 50 mic (2 mils) thick, heat-sealed to a closed cell polyethylene foam 11, the thickness of which ranges from 0.5 mm (0.02 inches) to 3 mm (0.12 inches), and a density of 18 kg/m³ (1.12 pcf) to 40 kg/cm³ (2.5 pcf), the lower face of which is heat-sealed to a second high-density polyethylene film 12, which is about 20 mic (0.8 mils) thick.

Over the marginal region of the first film matching the edge 10″ of the sandwiched membrane 10′ there is a pressure-sensitive selfadhesive strip a preferably made by two parallel strips 13 which are also parallel to said edge, and both strips are covered by a liner b which shall be removed when the membrane is laid. This is a hot melt that retains its properties over the time, both while being applied or after being sealed, and remains unaltered by moisture or brusque changes in climate.

This first polyethylene film 10, which is heat-sealed over the upper face of the sandwiched membrane outlays the polyethylene foam 11 width by 5 to 10% and also the film 12 of the lower face, thus making a longitudinal overlapping 10′″ intended to overlap the marginal region 10′ of the first film 10 wherein the selfadhesive strip a from other membrane is applied, the strip of other membrane is adjacently placed so as to be glued thereto.

Components of the Sandwiched Membrane

The sandwiched membrane is produced from polyethylene foam, a low-density polyethylene film, a high-density polyethylene film and an adhesive of the hot melt type.

Since most materials are produced from polyethylene, below there is a brief explanation about production and types of polyethylene that are available in the market.

Polyethylene resin used for film and foam production is obtained by means of polymerization of ethylene or polymerization of ethylene with any other aliphatic mono-olephin, for instance: propylene, 1-butene, 1-pentene or a mixture of several of them.

From this polymerization high-, medium- and low-density polyethylene resins are obtained.

Polyethylene foam is obtained from an extrusion process wherein the following raw materials are used:

Conventional low-density polyethylene having the following characteristics:

Density about 0.910 gr/m³ and 0.930 gr/m³.

Vicat softening point between 80° C. and 100° C.

Flow rate between 3 gr/10 min to 7 gr/10 min.

Butane gas as a foaming agent having the following characteristics:

Butane: 98%.

Pentane: 2%, maximum

Gas density between 2.4 kg/m³ and 2.6 kg/M³

Liquid density between 550 kg/m³ and 590 kg/m³

Volume ratio of gas/liquid between 220 and 230

Glyceryl monostearate as lubricant, having the following features:

Acidity index: 3%, maximum

Monoglyceride contents: 90%, minimum

Moisture: 2%, maximum

Melting point: 60-70° C.

Talc of 400 mesh as a binder having the following characteristics:

SiO₂: 60%, minimum

MgO: 30%, minimum

Moisture: 0.15%, maximum

During the extrusion process, polyethylene pellets are fed into the extruder by means of a gravimetric hopper wherein talc is also added in a ratio ranging from 0.5% to 1% by weight. Talc is used for controlling cell size (binder).

In the first section of the extrusion process a liquid lubricant is added under pressure in a ratio ranging from 1% to 3%. Lubricant is intended to modify the permeance of the polyethylene resin relative to the foaming agent, thus increasing the diffusion rate of the foaming agent to the outside region of the foam.

As a last step and in the middle line of the extruder, butane gas is injected as a foaming agent in a ratio ranging from 8% to 15%, which enters under pressure and in liquid state. During the whole pathway along the extruder, it mixes with the polyethylene and when the material leaves the head due to pressure difference between the inner part of the extruder and the environment, the gas turns into vapor state, thus forming the foam cells.

Some other additives may be also fed, such as flame-retardants, coloring agents and stabilizing agents, etc.

The foam thus obtained is wound in rolls having different length and is stored for 25 to 30 days, so the butane gas inside the cells is released, and the foam may be processed or conveyed without running any risk whatsoever.

Closed cell polyethylene foam obtained by means of the process previously described has different widths ranging from 0.5 mm (0.02 inches) to 3 mm (0.12 inches) and density of 18 kg/m³ (1.12 pct) to 40 kg/m³ (2.5 pcf).

A conventional extrusion process is used for the production of low-density polyethylene and high-density polyethylene.

The process comprises the extrusion of a polyethylene tube wherein air is injected for keeping the diameter thereof. Then, the tube is cooled and polyethylene is made to pass through rolls, which press the polyethylene, thus a single sheet or two sheets having the same width are obtained.

The low-density polyethylene film thus obtained is between 25 mic (1 mils) and 50 mic (2 mils) thick, and high-density polyethylene is about 20 mic (0.0 mils) thick.

In the first low-density polyethylene film 10 directions for correct anchoring and use precautions of the sandwiched membrane when used for arranging the underlayment for the floating flooring over the rigid foundation are provided.

Holt melt adhesive bears the following characteristics:

Softening point: 60° C. to 80° C.

Viscosity at 130° C.: 1200 cps; and at 160° C.: 400.

Application temperature ranges between 130° C. and 170° C.

Process for the Fabrication of Sandwiched Membrane

For obtaining a sandwiched membrane A a first and a second low-density polyethylene films 10 and the highdensity polyethylene film 12 are heat-sealed to the polyethylene foam 11.

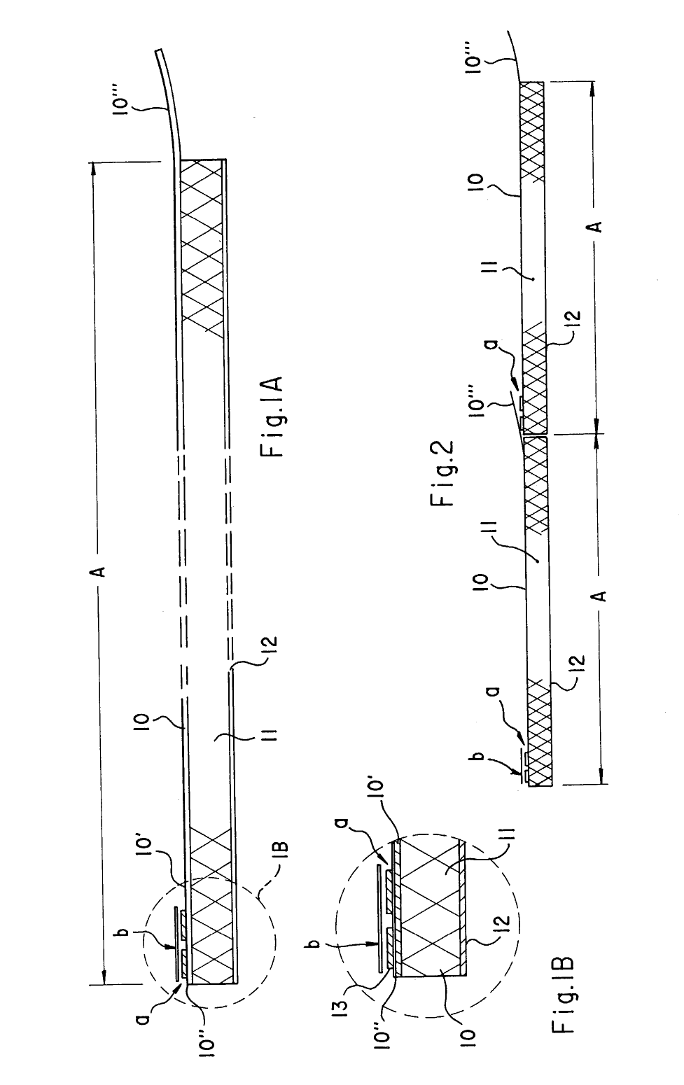

In FIG. 1 the scheme of the process is illustrated, wherein the heat-sealing is achieved by making the sandwich formed by low-density polyethylene film 10, polyethylene foam 11 and high-density polyethylene film 12 pass through two heated rolls 13 and 14.

Heated rolls temperature ranges from 120° C. to 160° C.

Due to this high temperature, when the films get in touch with the rolls, polyethylene becomes plastified as well as the foam surface, so the heat-sealing is obtained. In this way a completely safe joint is achieved, which will remain unaffected in the future.

Process for the Application of the Selfadhesive Element

Once the polyethylene films are heat-sealed, pressure-sensitive selfadhesive a and liner b are applied.

FIG. 2 is a schematic view of the process.

As the sandwiched membrane passes below the selfadhesive applicator 15, the applicator places the pressure-sensitive adhesive (hot melt) in the shape of two parallel threads.

The adhesive applicator comprises a heated vessel where the adhesive is melted at 120° C. to 140° C., then a gear wheel pump uptakes the melted adhesive and pressure-propels it through a nose which is heated up to the head; two adhesive threads leave from the head; the threads being applied over said strip 10″ of the film of the sandwiched membrane, thus forming said strips 13.

Membrane Anchoring

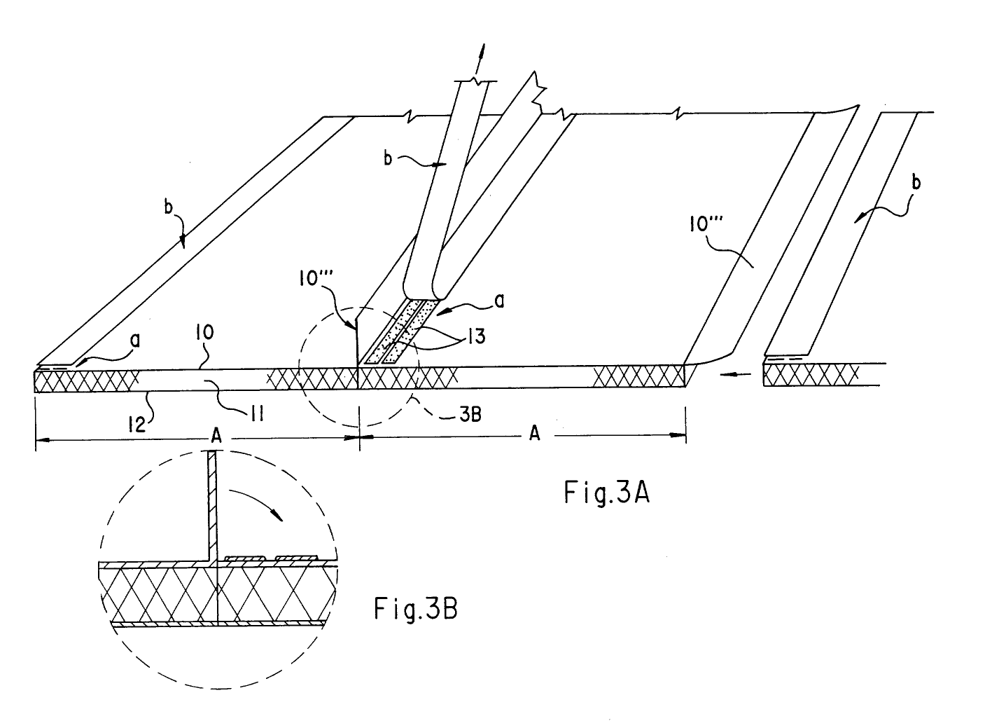

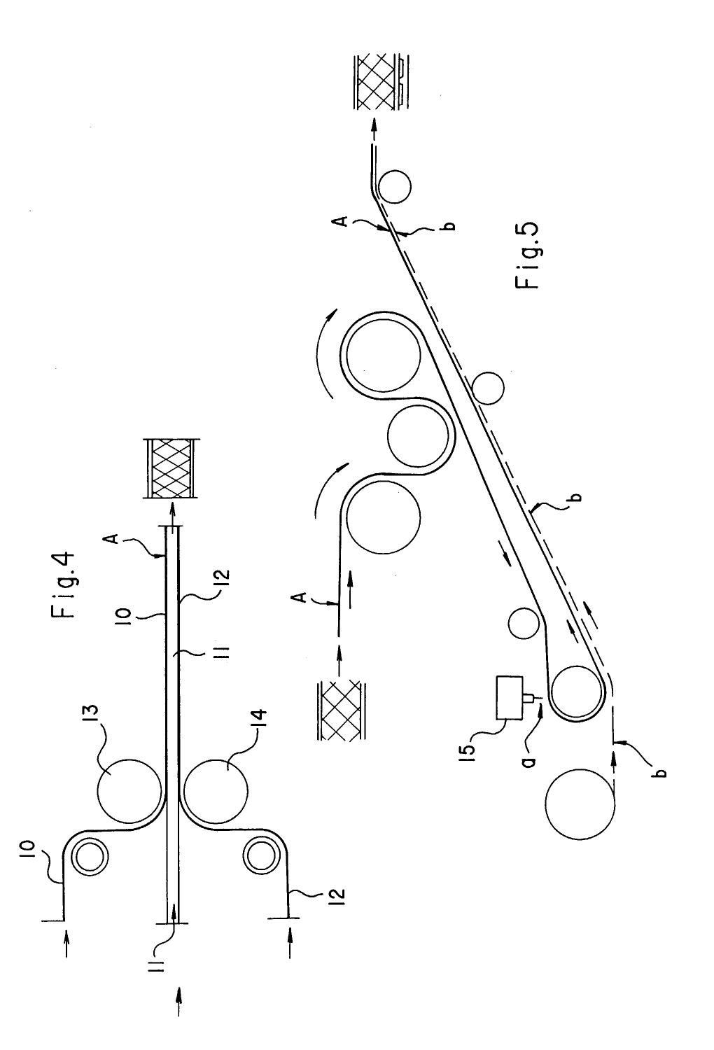

Sandwiched membrane is laid over the rigid foundation, concrete subfloor or existing floor; the face of the first film bearing the directions is placed upwards (rolls are unwound with the face upwards), so sandwiched membranes of both form a heading joint between the edges of the foam 11 and second film 12 which is directly fixed over the rigid foundation, such as may be seen in FIGS. 2 and 3.

Previously overlapping 10′″ is raised and placed beside the joint while liner b is removed; the overlapping is laid and firmly pressed over sheets 13 of the selfadhesive strip a; as a result a firm, tight mechanical association between both membranes is established.

This is how a single surface completely associated between different panels of the sandwiched membrane without any discontinuity is formed, ensuring the integrity of the vapor barrier.

This anchoring allows achievement of the following objects:

That the floating flooring “floats” over an underlayment formed by several panels of the sandwiched membrane without any discontinuity between them and without any possibility that a rupture of the underlayment may occur, since the membranes are sliding on both sides, as regards the flooring and the rigid foundation, and both films as well as the foam interlayered between them are completely free to accompany possible oscillations between them.

In other words, there is no possibility that a sort of “anchoring-retention” to the flooring or foundation may occur, so these sandwiched membranes create a sort of ancillary floating flooring or a complement to the floating flooring itself.

Sandwiched membrane provides an acoustic buffer, thus decreasing the impact noises (steps, objects falling down, etc.), which may be produced in a story and bother another story in the whole surface of the floating flooring without any acoustic bridge.

Sandwiched membrane absorbs any unevenness that the rigid foundation may have, so the floating flooring is perfectly anchored without any movement or unevenness.

With this product, anchoring results quicker and easier, while it cuts costs and installation takes shorter time.

In brief, it is evident that the sandwiched membrane above described, which is the subject matter of this invention, when used for laying floating floorings made of wood or melamine, acts as:

Free sliding element between the floating flooring and the rigid foundation;

Dampening material;

Leveler of small unevenness of the rigid foundation;

Acoustic buffer; and

Vapor barrier.

Essentially:

The underlayment for floating floorings is formed by a succession of sandwiched membranes according to this invention having polyethylene films on both faces of the foam. The characteristic of the foundation brings about the following properties:

It increases compression strength of the polyethylene foam, so resilience is improved while the useful life of the membrane as a damping element is extended.

It improves free expansion and contraction of the floating flooring due to changes in climate, thus preventing the membrane to become affected from any mechanical aggression, which also extends the useful life thereof.

It increases useful life of the polyethylene foam maintaining its properties.

As there is a vapor barrier on both sides, the foam becomes water repellant.

It shows improved pull strength and tear strength.

The foregoing characteristics show a clear difference between this sandwiched membrane as compared with the prior art of using polyethylene foam as a separator between the floating flooring and the subfloor, so it may freely float between them without any friction and accommodating for any movement that the flooring may have.

The preceding disclosure reveals a characteristic that helps to establish the difference between this membrane and the prior art; such characteristic is that when the floor is disassembled for any reason whatsoever, the foundation formed by the series of membranes may be reused in its original conditions, simply because of the full freedom of the membrane as regards the floating flooring and its rigid foundation.

Once the nature and scope of this invention has been described and specified, as well as the way of practicing it, the following is claimed as property and exclusive rights:

1. Underlayment for a floating flooring comprising a sandwiched membrane that may be used as a separator between the floating flooring and the rigid foundation thereof, characterized in that said membrane comprises a closed cell low-polyethylene foam whereto two polyethylene films are simultaneously heat-sealed; the films enwrap the foam in its entire width on both sides thereof, the first film is a thicker low-density polyethylene film having on the upper uncovered face thereof —and beside one of their edges—a pressure-sensitive selfadhesive strip, while the other edge projects beyond the foam edge thus forming an overlapping that may overlap and pressure-fix over the selfadhesive strip of the first film of a similar sandwiched membrane adjacently extended and establishing a heading joint between the edges of the foam of both membranes and of the second film, belonging to this overlapping; said overlapping overlaps this heading joint and thus it makes a mechanical tight association between the first thicker film of both membranes, at the same time making a continuous vapor barrier between both membranes, an acoustic buffer and a damping element, which extends along the whole arrangement of sandwiched membranes over the floor.

2. Underlayment for a floating flooring comprising a sandwiched membrane that may be used as a separator between the floating flooring and the rigid foundation thereof, as set forth in claim 1, characterized in that the thickness of the closed cell polyethylene foam ranges between 0.5 y 3 mm.

3. Underlayment for a floating flooring comprising a sandwiched membrane that may be used as a separator between the floating flooring and the rigid foundation thereof, as set forth in claim 1, characterized in that the density of the closed cell polyethylene foam ranges between 18 and 40 kg/m³.

4. Underlayment for a floating flooring comprising a sandwiched membrane that may be used as a separator between the floating flooring and the rigid foundation thereof, as set forth in claim 1, characterized in that the first low-density polyethylene film is between 25 and 50 mic thick.

5. Underlayment for a floating flooring comprising a sandwiched membrane that may be used as a separator between the floating flooring and the rigid foundation thereof, as set forth in claim 1, characterized in that the second high-density polyethylene film is about 20 mic thick.

6. Underlayment for a floating flooring comprising a sandwiched membrane that may be used as a separator between the floating flooring and the rigid foundation thereof, as set forth in claim 1, characterized in that the first polyethylene film extends from the edge of the foam beside which there is an adhesive strip overlapping the other edge by 5 to 10% of the foam width.

7. Underlayment for a floating flooring comprising a sandwiched membrane that may be used as a separator between the floating flooring and the rigid foundation thereof, as set forth in claim 1, characterized in that the self adhesive strip comprises a hot melt.

8. Underlayment for a floating flooring comprising a sandwiched membrane that may be used as a separator between the floating flooring and the rigid foundation thereof, as set forth in claim 1, characterized in that the uncovered face of the first polyethylene film where the selfadhesive strip is provided, includes installation directions and use precautions.
